(19) United States
(12) Patent Application Publication
(10) Pub. No.: US 2004/0139129 A1
(43) Pub. Date: Jul. 15, 2004

(54) Migrating a database

(76) Inventors: Takashi Okuyama, Kawasaki (JP); Ishikura Hiroki, Tokyo (JP)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/685,349

(22) Filed: Oct. 15, 2003

(30) Foreign Application Priority Data
Oct. 16, 2002 (JP) 2002-301445

(51) Int. Cl. G06F 17/30

(52) U.S. Cl. 707/204

(57) ABSTRACT

Migrating a database from a first system including a first storage device to a second system including a second storage device includes: making a backup copy of data stored in the first storage device; storing the backup copy in the second storage device; creating update information of the data after the backup copy is made in the first storage device; and storing the update information of the data in the second storage device.

### CROSS-REFERENCE TO RELATED APPLICATIONS AND CLAIM OF PRIORITY

The present invention relates to Japanese Patent Application #2002-301445, filed in Japan on Oct. 16, 2002, and priority thereof is hereby claimed under 35 USC 119.

### BACKGROUND OF THE INVENTION

1. Field of the Invention

The present invention relates to computer system database migration and, more specifically, to migrating a database to any hardware environment without losing consistency thereof.

2. Description of the Related Art

Databases have been widely popular with electronic commerce systems, specifically in intra-corporate systems, Business-to-Business (B2B) systems, and Business-to-Consumer (B2C) systems. Corporations and organizations construct their own database systems depending on the amounts of data to be handled and the nature of transactions involving the database systems.

A problem often arises in database processing due to unexpected circumstances beyond the storage capacity and processor capability required for the hardware incorporating the database. For example, in a consumer-targeting sales system, such unexpected circumstances occur as a result of an increase in the data amounts and transactions resulting from an increase in the number of customers, an increase in the number of products, a requirement for more detailed information about the products (e.g., products' photographic information), and the like.

To prevent such a problem from occurring, if a prediction is made in advance that the processor capability will be not sufficient, system migration is accordingly affected. Specifically, any data stored in the existing database is retained, while the hardware of the database system is replaced with other hardware having greater capabilities.

At the time of such system migration, that is, to migrate the current database system (previous system) to another database system (new system) through replacement, the following approach is taken. That is, updating the previous system is prohibited, a backup copy of the data stored in the previous system is stored on a magnetic tape, for example, the resulting backup copy is restored into the new system, and the new system is started after completion of restoring.

For retaining database consistency, no database can be updated in the previous system during data copying from the previous system to the new system. Thus, the system must be stopped during such data copying. For example, it can take 20 hours or longer for migrating, e.g., backing up or restoring, about 2 TBs (terabytes) of data. During this period of time, the system must be stopped. If the amount of data is increased, the system must be stopped for a longer period of time.

Stopping the system causes an inconvenience to users, and thus shortening the stop time needed for the migration is better for the users.

Furthermore, it can be impossible for some business operations to stop their systems for such a long time. If this is the case, system migration has to be completed during certain non-working time such as midnight or weekends so as not to affect other job processing.

Still furthermore, if certain criteria are not met for system migration, e.g., if the system migration is not completed, the system can again have to be stopped to complete the migration.

Therefore, an object of the present invention is to shorten the stop time of the system needed for system migration.

Another object of the present invention is to not cause any inconvenience for system end users without getting their attention even if the system is stopped for system migration.

Still another object of the present invention is to not affect other business operations, in consideration of system managers, by completing system migration during ordinary non-working hours.

Yet another object of the present invention is to minimize an influence over system integrators in charge of system migration if certain criteria are not met for system migration.

### SUMMARY OF THE INVENTION

According to an aspect of the present invention, a method is provided to migrate a database from a first system including a first storage device to a second system including a second storage device. The method includes making a backup copy of data stored in the first storage device; storing the backup copy of the data in the second storage device; creating update information of the data after the backup copy has been made in the first storage device; and storing the update information of the data in the second storage device.

Preferably, a magnetic tape stores the backup copy of the data in the second storage device.

A network can be used to store the update information of the data in the second storage device.

An online backup copy can be created as the backup copy of the data stored in the first storage device.

In creating the update information of the data, the last update information can be defined, and updating of the data is preferably prohibited before the defined last update information.

The data can be updated until prohibited, thereby shortening the stop time needed for system migration.

The update information of the data can be created at regular time intervals.

The second system can be started after database switching from the first system to the second system.

According to another aspect of the present invention, a device is provided to migrate a database from a first system including a first storage device to a second system including a second storage device. The device includes: a storage medium for transferring a backup copy of data stored in the first storage device to the second storage device, and a transfer medium for transferring upgrade information created in the first storage device to the second storage device.

According to still another aspect of the present invention, a second database system is constructed based on a first database system by a method including the steps of: copying data stored in the first database system into the second database system; and copying update information stored in the first database system into the second database system.

According to yet another aspect of the present invention, a computer program product causes a computer system to migrate a database from a first system including a first storage device to a second system including a second storage device. The computer program product includes: a computer execution step including transferring a backup copy of data stored in the first storage device to the second storage device; and another computer execution step including transferring update information created in the first storage device to the second storage device.

### BRIEF DESCRIPTION OF THE DRAWINGS

FIG. 1 is a block diagram of the structure of a previous database system before performing system migration in accordance with an aspect of the present invention;

FIG. 2 is a block diagram of the structure of a new database system after performing system migration in accordance with an aspect of the present invention;

FIG. 3 is a flowchart of a method of migration from the previous database system to the new database system utilizing a standby database function in accordance with an aspect of the present invention;

FIG. 4 is a schematic diagram of the method of migration from the previous database system to the new database system utilizing the standby database function;

FIG. 5 is a flowchart of the method of migration from the previous database system to the new database system utilizing online backup data in accordance with an aspect of the present invention; and

FIG. 6 is a schematic diagram of the method of migration from the previous database system to the new database system utilizing the online backup data.

### DETAILED DESCRIPTION

The accompanying drawings provide a better understanding of the present invention. In the drawings, components are not necessarily of the same scale, and have been emphasized to clarify the present invention. Furthermore, similar components in the drawings have the same reference numerals.

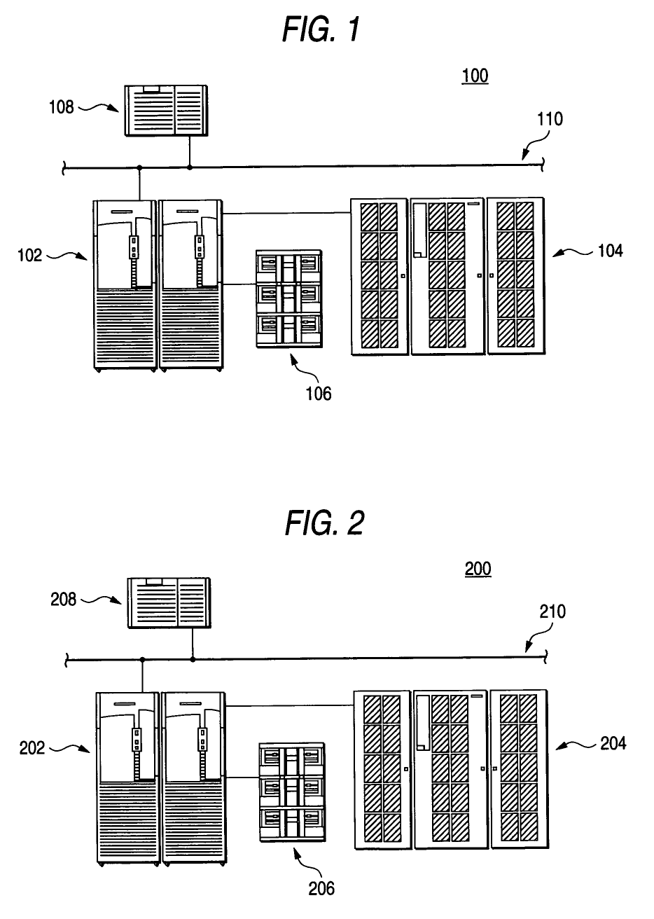

FIG. 1 is a block diagram of the structure of a previous database system (hereinafter, referred also to as a previous system) 100 before system migration, to which an aspect of the present invention is applied. The previous database system 100 includes a database server 102, a database storage device 104, a backup copy storage device 106, a backup management server 108, and a line 110 connecting together the database server 102 and the backup management server 108. Herein, the database storage device 104 and the backup copy storage device 106 are each connected to the database server 102.

Responding to a request coming from a client (not shown), the database server 102 goes through processes such as retrieving or updating data stored in the database storage device 104 using database software (not shown). The result is then forwarded to the client, and if required, stored in the database storage device 104. The database server 102 can be a server, a main frame, or a personal computer. The database software includes an archive log function, and Oracle 8i of the Oracle Corporation can be used, for example.

The database storage device 104 stores database software, data, and database control information. The database storage device 104 can be a magnetic disk device, an optical magnetic storage device, an optical storage device, or a tape storage device. The most preferable option is a magnetic disk device.

The backup copy storage device 106 is used for system migration, and stores a copy of information stored in the database storage device 104. The backup copy storage device 106 can be a magnetic disk device, an optical magnetic storage device, an optical storage device, or a tape storage device. A magnetic storage device is the most preferable option. The backup copy storage device 106 is used for system migration, and is not necessarily needed when the system is normally operated.

The backup management server 108 operates the database server 102 and the database storage device 104 for database backup using backup management software (not shown). The backup management server 108 can be a server, a main frame, or a personal computer. The backup management software can be Omniback II of Hewlett Packard Company, for example. The backup management server 108 is used for system migration, and is not necessarily needed when the system is normally operated. If a backup function of any operating system (OS) incorporated in the database server 102 is used, there is no need for the backup management server 108.

The line 110 electrically connects the database server 102 to the backup management server 108. The line 110 can be a local area network (LAN), a wide area network (WAN), the Internet, or a peer-to-peer LAN.

FIG. 2 is a block diagram of the structure of a new database system (hereinafter, referred also to as new system) 200 after system migration, to which an aspect of the present invention is applied. The new database system 200 includes a database server 202, a database storage device 204, a backup copy storage device 206, a backup management server 208, and a line 210 for connecting the database server 202 to the backup management server 208. The database storage device 204 and the backup copy storage device 206 are each connected to the database server 202.

The database server 202 and the database storage device 204 are those provided in place of the database server 102 and the database storage device 104 of FIG. 1, and are preferably of a higher capability and a larger capacity than the database server 102 and the database storage device 104. The database software needs, in principle, to remain the same both before and after system migration. However, if possible, the database software is preferably upgraded depending on its function.

The backup copy storage device 206, the backup management server 208, and the line 210 are similar to and can identify with the backup copy storage device 106, the backup management server 108, and the line 110 of FIG. 1. The backup copy storage device 206, the backup management server 208, and the line 210 are used for system migration, and are not necessarily needed when the system normally operates.

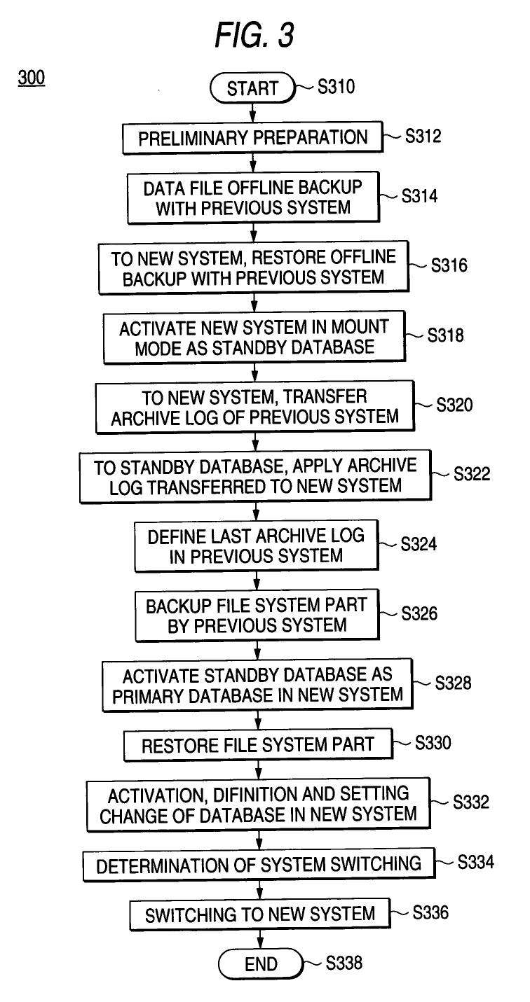

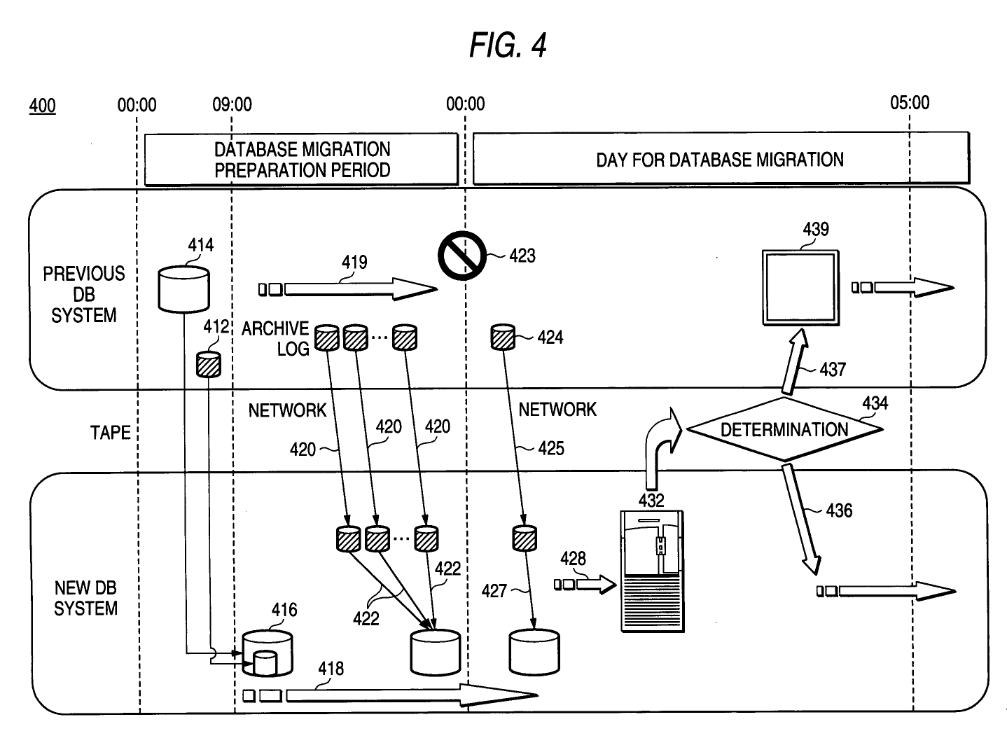

FIG. 3 is a flowchart of a method of migration from the previous database system 100 to the new database system 200 utilizing a standby database function according to an aspect of the present invention. FIG. 4 is a schematic diagram of the method of migration from the previous database system 100 to the new database system 200 utilizing a standby database function. A description follows of the method of migration from the previous database system 100 to the new database system 200.

Referring to FIG. 3, the method of migration in accordance with an aspect of the present invention is started in step 310, and preliminary preparation for migration is made in step 312. Such preparation for migration can be management file creation for standby database (refer to magnetic tape 412 in FIG. 4), logic volume setting in the new system, and the like. The standby database is a database system (database system 200 before system migration) used for backup rather than a primary database (previous database system 100 before system migration) being a database used for ordinary business operations.

In step 314, the data file is subjected to offline backup in the previous system 100. Offline backup is backup that is carried out while ordinary business operations are not running. Specifically, offline backup is carried out by the backup management server 108 making a copy of backup data stored in the database storage device 104 on a magnetic tape contained within the backup copy storage device 106 (refer to magnetic tape 414 in FIG. 4). In view of measures taken against system failure, this offline backup is preferably carried out not only during system migration but also during normal system operation at regular intervals, e.g., daily, weekly, monthly. The management file for standby database is also backed up.

After step 314 of subjecting the data file in the previous system to offline backup, the result of the offline backup in the previous system is restored in the new system 200 in step 316. The restoring in the new system 200 of the offline backup is effected by storing a copy from the magnetic tape including the backup data stored therein in step 314 in the database storage device 204 in the new database (refer to magnetic tape 416 in FIG. 4). In more detail, the magnetic tape reference 412 including the backup data is contained within the backup copy storage device 206, the backup management server 208 makes a setting for restoring, and the backup data is then restored in the database storage device 204. At this time, the management file created in step 314 for standby database is also restored.

After step 316 of restoring, in the new system 200, the offline backup copy made in the previous system, the new database system is started in step 318 as a standby database 318 as indicated by arrow 418 in FIG. 4.

After step 318 of starting the new database system as a standby database, the archive log of the previous system is transferred to the new system 200 in step 320. The archive log includes update information (update time and day, and update details) of the database created after the last backup. By applying such an archive log to the backup data (roll forward), the database can be reconstructed. The archive log is also called a journal log.

If system migration is not actually performed soon (e.g., about 7 to 10 days) after the day of offline backup (step 314), and if the previous database system is kept running during that time for ordinary business operations as indicated by arrow 419 in FIG. 4, the archive log is preferably transferred a plurality of times to the new as indicate by arrow system 200 partially so as not to cause any trouble for ordinary business operations as indicated by arrow 420 in FIG. 4. The archive log can be transferred from time to time at regular intervals, e.g., every day, every hour, or at irregular intervals, e.g., whenever a certain storage capacity has been reached. Moreover, the archive log can be transferred via a magnetic tape, or over a network.

The archive log transferred to the new database system 200 in step 320 is applied to the standby database in step 322. The archive log can be applied to the standby database every time the archive log is transferred or at one time (refer to magnetic tape 422 in FIG. 4). It should be noted here that the new database system 200 is not used for ordinary business operations before system migration, and thus unlike step 320 of the archive log transfer, application of the archive log can be performed whenever necessary.

After step 322 of applying the archive log to the standby database, a definition is made in step 324 that is the last archive log of the previous system (refer to magnetic tape 424 in FIG. 4). To prevent the database from being updated after the definition of the last archive log, it is desirable to stop in advance the ordinary business operations indicated by stop sign 423 in FIG. 4. After the last archive log is transferred to the new system as indicated by arrow 425 in FIG. 4 for application in the new system 200 as indicated by arrow 427 in FIG. 4, the database in the previous system is stopped.

After the last archive log of the previous system is defined in step 324, if required, the file system part of the previous system such as shell scripts varying in type or application log files is backed up in step 326. For backup, using a plurality of servers is preferable to shortening the time needed for restoration.

After step 326 of backing up the file system part of the previous system, the standby database is started in the new system 200 as the primary database 100 in step 328. The new system 200 is then checked to determine whether every archive log has been completely applied therein, and the database in the new system is then activated as indicated by arrow 428 of FIG. 4. Once the database is activated, no archive log is to be applied.

The database is temporarily stopped and then started again to see if the database can be normally started after the database in the new system has been activated.

The file system part is restored in step 330 after step 328 of starting the standby database in the new system 200 as the primary database. If plural servers are used for backup in step 326, the time needed for restoration can be shortened by those servers operating simultaneously.

After step 330 of restoring the file system part, if required, the database in the new system 200 is checked if the new system has been started, and the setting of the new system is changed in step 332 as indicated by arrow 432 of FIG. 4. Further, the application-level database operation is preferably checked for use as a determination factor for system switching.

After step 332 of database starting check and setting change of the new system 200, if required, a determination 434 is made about system switching to the new system 200 in step 334 (see 434 in FIG. 4). If the system is switched to the new system 200, the system after switching is monitored for problems.

If it has been determined in step 334 that system switching is to be effected as indicated by arrow 436 in FIG. 4, the system is accordingly switched to the new system 200 so the system is ready for ordinary business operations using the new system. Also, the system after switching is monitored for problems.

On the other hand, if it has been determined in step 334 that no system switching is to be effected, as indicated by arrow 437 in FIG. 4, the previous system 100 is started so the system is ready for ordinary business operations using the previous system, as indicated by arrow 439 in FIG. 4.

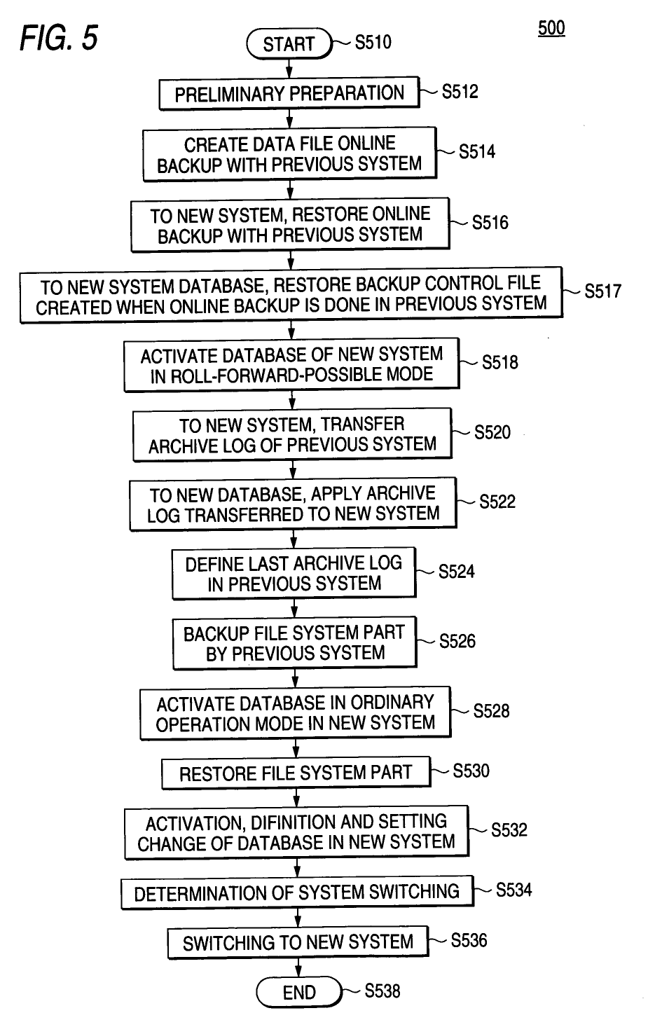

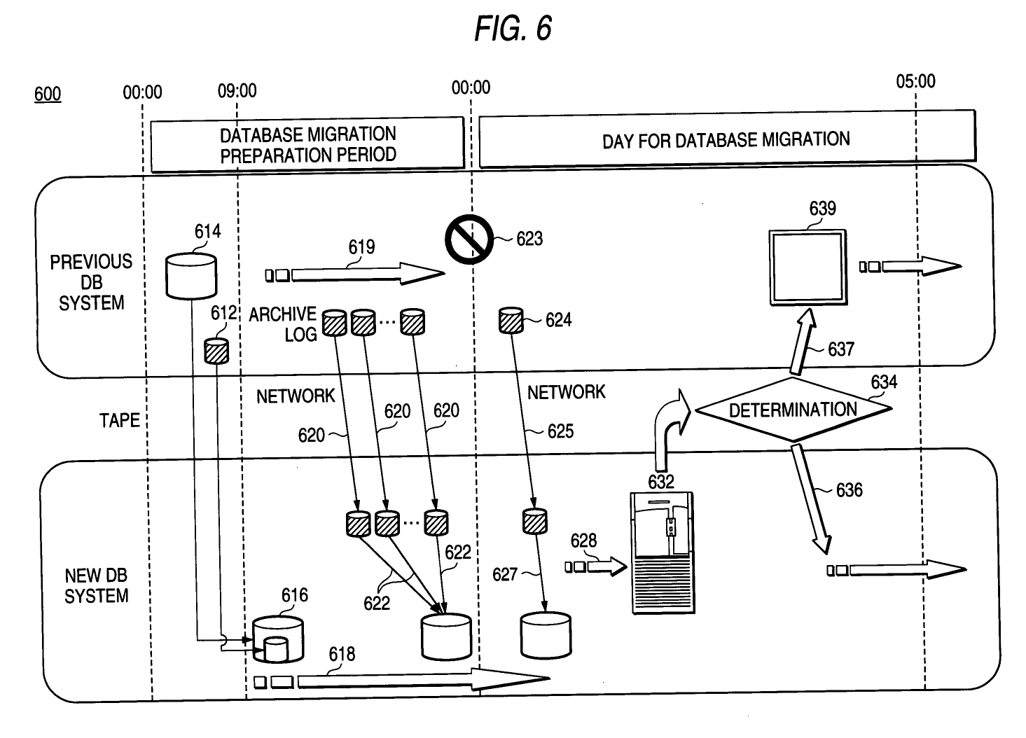

FIGS. 5 and 6 are respectively a flowchart and a block diagram of the method of migration from the previous database system 100 to the new database system 200 using online backup data.

In this method, the previous database system 100 and the new database system 200 are similar in structure to those of FIGS. 1 and 2.

FIG. 5 is a flowchart of the method of migration from the previous database system 100 to the new database system 200 using online backup data according to an aspect of the present invention. FIG. 6 is a schematic diagram of the method of migration from the previous database system 100 to the new database system 200 using the online backup data.

The following is a description of the method of migration from the previous database system 100 to the new database system 200, referring to FIGS. 1, 2, 5, and 6.

Referring first to FIG. 5, the method of migration in accordance with an aspect of the present invention is started in step 510, and preliminary preparation for migration is made in step 512. Such preparation for migration can be logic volume setting in the new system, for example. As a database management file, any existing backup management file is used without newly creating a control file for standby database. This is not applicable if a database that does not have a database management file is used. In this method, the previous system 100 and the new system 200 are not in a relationship as a primary database and a standby database as in the previous arrangement, but rather each operate as independent databases.

In step 514, the data file is subjected to online backup in the previous system 100. Online backup is backup carried out without stopping ordinary business operations. Specifically, online backup is carried out by the database server 102 storing a backup copy of the data file in the database storage device 104 or in another different storage device for backup at regular or irregular intervals. If needed, as to the management file, a backup management file is created with the same timestamp as the data file (see magnetic tape 612 in FIG. 6). In such a manner, even if the database is updated, the online backup is not updated for a certain length of time. Accordingly, the backup data file and the backup management file can be copied on a magnetic tape without stopping ordinary business operations.

After step 514 of subjecting the data file in the previous system to online backup, the result of the online backup in the previous system is restored in the new system in step 516. This restoration is effected by making a copy the data from the magnetic tape 614 including the backup data stored therein in step 514 to the database storage device 204 in the new database system as indicated by arrow 616 in FIG. 6. In more detail, the backup data on magnetic tape 614 is stored in the backup copy storage device 206, the backup management server 208 makes a setting for restoration, and the backup data is then restored in the database storage device 204.

After step 516 of restoring the online backup in the previous system 100 to the new system 200, if needed, the backup management subjected to backup by the previous system file of the previous system is restored in the new system in step 517 (see step 514).

After step 517 of restoring, if required, the backup management file into the new system, in step 518, the database in the new system is started in roll-forward-possible mode, e.g., the mount mode in Oracle 8i as indicated by arrow 618 in FIG. 6.

After step 518 of starting the database in the new system 200 in the roll-forward-possible mode, the archive log of the previous system 100 is transferred to the new system in step 520. The archive log includes update information (update time and day, and update details) of the database created after the last backup. By applying such an archive log to the backup data (roll forward), the database can be reconstructed. The archive log is also called a journal log.

If system migration is not actually performed soon (e.g., about 7 to 10 days) after the day of online backup (step 514), and if the previous database system is kept running during that time for ordinary business operations as indicated by arrow 619 in FIG. 6, the archive log is preferably partially transferred to the new system for a plurality of times so as not to cause any trouble for ordinary business operations as indicated by arrow 620 in FIG. 6. The archive log can be transferred at regular intervals, e.g., every day, every hour, or at irregular intervals, e.g., whenever a certain storage capacity has been reached. Moreover, the archive log can be transferred via a magnetic tape, or over a network.

The archive log transferred to the new database system in step 520 is applied to the new database in step 522. The archive log can be applied to the new database every time the archive log is transferred or at one time as indicated by arrow 622 in FIG. 6. The new database system is not used for ordinary business operations before system migration, and thus unlike step 520 of archive log transfer, application of the archive log can be done whenever necessary.

After the archive log is applied to the database in the new system 200 in step 522, a last archive log of the previous system is defined in step 524 (see magnetic tape 624 in FIG. 6. To prevent the database from being updated after the defined last archive log, it is desirable to stop the ordinary business operations in advance as indicated by stop sign 623 in FIG. 6. After the last archive log is transferred to the new system 200 as indicated by arrow 625 in FIG. 6 for application in the new system 200 as indicated by arrow 627 in FIG. 6, the database in the previous system 100 is stopped.

After the last archive log of the previous system is defined in step 524, a file system part of the previous system, such as shell scripts varying in type, or application log files is backed up in step 526, if needed. For backup, using a plurality of servers is preferable to shorten the time needed for restoration.

After step 526 of backing up the file system part in the previous system 100, the database in the new system 200 is started in step 528 in an ordinary operation mode, e.g., an open mode in Oracle 8i as indicated by arrow 628 in FIG. 6. The new system 200 is then checked to determine if every archive log has been completely applied therein.

Preferably, after the database in the new system 200 is started in the ordinary operation mode, the database is temporarily stopped and then started again to see if the database can be normally started.

After step 528 of starting the database in the new system in the ordinary operation mode, the file system part is restored in step 530. If plurality servers are used for backup in step 526, the time taken for restoration can be shortened by those servers restoring simultaneously.

After step 530 of restoring the file system part, if needed, the database in the new system 200 is checked if it has been started, and the setting thereof is changed in step 532 as indicated by arrow 632 in FIG. 6. Further, the application-level database operation is preferably checked for use as a determination factor for system switching.

After step 532 of performing a database starting check and setting change whenever necessary in the new system, a determination 634 of switching to the new system 200 is performed in step 534. If the system has been switched to the new system 200, the system after switching is monitored for problems.

If it has been determined in step 534 that the switching to the new system 200 is to be effected as indicated by arrow 636 in FIG. 6, the switching to the new system 200 is accordingly effected, so that the system is ready for ordinary business operations using the new system. Also, the system after switching to new system 200 is monitored for problems.

On the other hand, if it has been determined in step 534 that no system switching is to be effected as indicated by arrow 637 in FIG. 6, the previous system 100 is started so that the system is ready for ordinary business operations using the previous system (see 639 in FIG. 6).

In this method, offline backup can be utilized instead of online backup.

The present invention can be realized in any number of examples through hardware, software, or a combination thereof. Further, the present invention can be incorporated into a computer program product arranged to execute such a method on a computer system.

According to the present invention, the stop time of the system needed for system migration can be successfully shortened.

Further, thanks to the present invention, system end users do not feel inconvenience, without noticing, even if the system is stopped for system migration.

Still further, according to the present invention, no influence is wielded to other business operations, in consideration of system managers, by completing system migration during ordinary non-working hours.

Still further, according to the present invention, an influence can be favorably minimized to system integrators in charge of system migration even if certain criteria are not met for system migration.

What is claimed is:

1. A method of migrating a database from a first system including a first storage device to a second system including a second storage device, the method comprising:
making a backup copy of data stored in the first storage device;
storing the backup copy in the second storage device;
creating update information of the data after the backup copy has been made; and
storing the update information of the data in the second storage device.

2. The method according to claim 1, wherein storing the backup copy in the second storage device comprises storing the backup copy on a magnetic tape.

3. The method according to claim 2, wherein storing the update information of the data in the second storage device comprises storing the update information of the data in the second storage device via a network.

4. The method according to claim 1, wherein the step of making the backup copy of the data stored in the first storage device comprises making an online backup copy.

5. The method according to claim 1, wherein creating the update information of the data comprises defining a last update information, and wherein the data is prohibited from being updated before the defined last update information.

6. The method according to claim 5, wherein the data is updated until the update of the data is prohibited.

7. The method according to claim 1, wherein the update information of the data is created at regular time intervals.

8. The method according to claim 1, further comprising running the second system after database switching from the first system to the second system.

9. An apparatus for migrating a database from a first system including a first storage device to a second system including a second storage device, the apparatus comprising:
a storage medium adapted to transfer a backup copy of data stored in the first storage device to the second storage device, and
a transfer medium adapted to transfer upgrade information created in the first storage device to the second storage device.

10. A method of constructing a second database system based on a first database system, the method comprising:
copying data stored in the first database system into the second database system; and
copying update information stored in the first database system into the second database system.

11. A computer program product for causing a computer system to migrate a database from a first system including a first storage device to a second system including a second storage device, the computer program product comprising:
a first computer execution step including transferring a backup copy of data stored in the first storage device to the second storage device; and
a second computer execution step including transferring update information created in the first storage device to the second storage device.

12. A program storage device, readable by a machine, tangibly embodying a program of instructions executable by the machine to perform the method of claim 1.

13. The program storage device of claim 12, wherein the method further comprises the method of claim 2.

14. The program storage device of claim 13, wherein the method further comprises the method of claim 3.

15. The program storage device of claim 12, wherein the method further comprises the method of claim 4.

16. The program storage device of claim 12, wherein the method further comprises the method of claim 5.

17. The program storage device of claim 16, wherein the method further comprises the method of claim 6.

18. The program storage device of claim 12, wherein the method further comprises the method of claim 7.

19. The program storage device of claim 12, wherein the method further comprises the method of claim 8.

20. A program storage device, readable by a machine, tangibly embodying a program of instructions executable by the machine to perform the method of claim 10.
